(19) United States
(12) Patent Application Publication
(10) Pub. No.: US 2011/0231238 A1
(43) Pub. Date: Sep. 22, 2011

(54) METHODS, SYSTEMS, AND COMPUTER READABLE MEDIA FOR TRACKING REDEEMED ELECTRONIC CERTIFICATE AND CONSUMER DATA ASSOCIATED WITH A MOBILE DEVICE

(76) Inventors: Mohammad Khan, San Jose, CA (US); Roshan Vijayshankar, Santa Clara, CA (US)

(21) Appl. No.: 13/069,322

(22) Filed: Mar. 22, 2011

Related U.S. Application Data
(60) Provisional application No. 61/316,254, filed on Mar. 22, 2010.

(51) Int. Cl. G06Q 30/00

(52) U.S. Cl. 705/14.26; 705/14.1; 705/14.38

(57) ABSTRACT

Methods, systems, and computer readable media for tracking redeemed electronic certificate and consumer data associated with a mobile device are disclosed. In one embodiment, a method includes receiving, at a wireless device reader, electronic certificate data and consumer identification data, redeeming the electronic certificate data, and generating redemption tracking data using the redeemed electronic certificate data and consumer identification data.

### PRIORITY CLAIM

This application claims the benefit of U.S. Provisional Patent Application No. 61/316,254, filed on Mar. 22, 2010, the disclosure of which is incorporated herein by reference in its entirety.

### TECHNICAL FIELD

The presently disclosed subject matter relates generally to tracking electronic certificates. More particularly, the present subject matter described herein relates to methods, systems, and computer readable media for tracking redeemed electronic certificate and consumer data associated with a mobile device.

### BACKGROUND

Use of short distance radio frequency enabled devices, such as near field communications (NFC) mobile handsets, stickers or add-on NFC accessories by consumers, is steadily increasing. Notably, NFC enabled devices have allowed users of mobile phones and contactless cards to more readily participate in loyalty programs, participate in membership programs, and redeem electronic coupons, offers, or rewards. Due to the increasing ease of participating in these types of programs, there is a strong desire by manufacturers and retailers to track electronic certificates (e.g., electronic coupons, tickets, and the like) and consumer data through contactless and NFC redemption schemes in order to understand the purchasing behavior of consumers.

With the advent of the mobile users participating in electronic-based marketing campaigns, existing means of certificate data collection and integration models have become obsolete and outdated. Specifically, the present study of coupon usage and consumer behavior is currently based on manually interviewing thousands of respondents. This is a costly, slow and an error-prone process. Additionally, it is difficult to track the buying habits of consumers in physical stores on a national level because cash transactions are not recorded by current marketing databases.

Accordingly, a need exists for improved methods, systems, and computer readable media for tracking redeemed electronic certificate and consumer data associated with a mobile device.

### SUMMARY

Methods, systems, and computer readable media for tracking redeemed electronic certificate and consumer data associated with a mobile device are disclosed. In one embodiment, a method includes receiving, at a wireless device reader, electronic certificate data and consumer identification data, redeeming the electronic certificate data, and generating redemption tracking data using the redeemed electronic certificate data and consumer identification data.

The subject matter described herein may be implemented in software, in combination with hardware and/or firmware. For example, the subject matter described herein may be implemented in software executed by a processor. In one exemplary implementation, the subject matter described herein for tracking redeemed electronic certificate and consumer data associated with a mobile device may be implemented using a non-transitory computer readable medium to having stored thereon executable instructions that when executed by the processor of a computer control the processor to perform steps. Exemplary non-transitory computer readable media suitable for implementing the subject matter described herein include chip memory devices or disk memory devices accessible by a processor, programmable logic devices, and application specific integrated circuits. In addition, a computer readable medium that implements the subject matter described herein may be located on a single computing platform or may be distributed across plural computing platforms.

### BRIEF DESCRIPTION OF THE DRAWINGS

The subject matter described herein will now be explained with reference to the accompanying drawing of which:

FIG. 1 is a block diagram of an exemplary system configured to track redeemed electronic certificate and consumer data according to an embodiment of the subject matter described herein.

### DETAILED DESCRIPTION

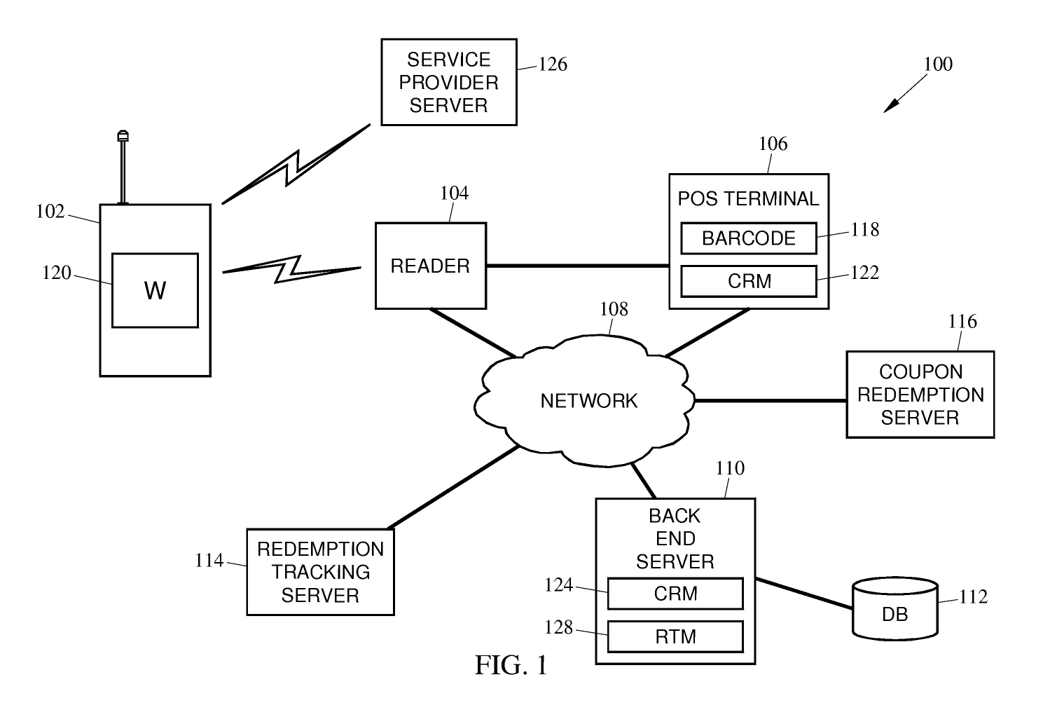

FIG. 1 depicts a certificate and consumer data collection system 100 that is utilized for tracking redeemed electronic certificate and consumer identification data. As used herein, electronic certificate data may include electronic coupon data, loyalty program data, reward data, membership data, offer data, an electronic certificate identifier, electronic coupon booklet, an electronic offer booklet, and an electronic reward booklet. Electronic coupon data may include for example, an expiration date, graphical information, qualifying data, a specification code, a number of times the coupon may be used, multiplying (doubling or tripling coupon value) information, and the like. Qualifying data can include product sizes, price amount, or quantities that must be purchased before an electronic coupon may be redeemed. Similarly, consumer identification data may comprise a membership number, a credit card number, a loyalty number, a prepaid card number, a gift card number, a ticket number, a geographic location, a graphic, photographic data, a mobile device number, and other such information that is associated with a particular consumer user. In one embodiment, electronic certificate data and consumer identification data can be stored on a mobile device 102 which may include any one of a near field communications (NFC) integrated mobile phone, an NFC enabled mobile phone, an add-on sticker, an add-on NFC accessory (e.g., microSD cards), a contactless card, a magnetic stripe card, a smart card, and the like.

In one embodiment, electronic certificate data and consumer identification data is transmitted via NFC to an intelligent wireless device reader 104 that may be located in a physical merchant point of sale (POS) environment. Wireless device reader 104 may include any type of device that is capable of wirelessly communicating data via near field communications (NFC). As used herein, NFC may include any and all wireless communications methods operating at 13.56 Mhz. Wireless device reader 104 can be connected to a communication port of a POS system terminal 106 which may be used to electronically transfer credit, debit, or prepaid payment transaction information. POS system terminal 106 may include any computing device positioned at a merchant location that is capable of receiving transaction information from reader 104 and processing redemption data. For example, POS system terminal may receive electronic certificate data and purchase data (e.g., price and quantity of goods) and calculate redemption data (i.e., updated price data after electronic coupon data has been applied to goods to be purchased). POS system terminal 106 may also include any terminal or device used in physical merchant environments that accept paper certificates through using barcode scanning and that accept payments using magnetic stripe or contactless cards. In one embodiment, the communication port may comprise a barcode port, universal serial bus (USB) port, a PS/2 port, and the like. In one embodiment, the barcode port may be connected through a first universal serial bus (USB) port, a PS/2 port, a serial port, and/or some other electrical interface that is normally configured to accept data from a barcode scanner 118 (e.g., UPC format or other formats). In the event there is more than one type of electronic certificate information to be sent to POS system terminal 106, wireless device reader 104 may be configured to sequentially send barcode emulated data one coupon/offer/reward at a time with induced delays (e.g., to emulate a human sales clerk scanning coupons through scanning a barcode reader on multiple paper coupons as typically done in physical POS environments). Wireless device reader 104 may also be connected to a second USB port of POS system terminal 106 in order to receive electronic coupon redemption data.

System 100 may also include a communications network that is used to connect each of reader 104 and POS system terminal 106 to a back end server 110. Network 108 may include any communication network for transferring data, such as a wired or wireless local area network (LAN), broadband network, WiFi network, Internet protocol (IP) network, GPRS network, a CDMA network, or some other like network.

In one embodiment, a user may possess an NFC enabled device 102 that contains consumer identification data and one or more electronic certificates, e.g., electronic coupons or an electronic coupon booklet, selected by the user. Consumers may select the electronic coupons on mobile device 102, through a graphical display, or online to redeem and interact with wireless device reader 104 via NFC using a contactless/NFC tap or proximity interfacing. Selections may be made at or before arriving to the point of certificate redemption. The user may interface NFC enabled device 102 with reader 104, which wirelessly transfers the consumer identification information and the electronic coupons to reader 104. In one embodiment, reader 104 forwards the consumer identification data and the electronic coupons to POS system terminal 106 via a one or more communication ports connecting the two devices. Upon receiving the consumer identification information and electronic coupons, POS system terminal 106 utilizes an electronic coupon redemption module 122 (executed by a processor in the POS system terminal 106) to redeem the electronic coupons while completing the purchase transaction. For example, electronic coupon redemption module 122 may include hardware logic or a software program/module that when executed by a processor communicates with a coupon redemption server 116. Coupon redemption server 116 may be provisioned with a database of valid and/or invalid electronic coupons. If the electronic coupon used in the purchase transaction being performed by POS system terminal 106 matches a valid entry, the purchase transaction and a coupon redemption process is conducted by POS system terminal 106. After an electronic coupon is redeemed, POS system terminal 106 generates redemption tracking data associated with the redeemed electronic coupon. The redemption tracking data may include the type of electronic coupon redeemed (i.e., product purchased and amount of coupon), an identifier associated with the consumer that utilized the electronic coupon, and the time and location (e.g., a smart poster in a particular store) from which the electronic coupon was acquired by the consumer user. In one embodiment, POS system terminal 106 provides the redemption tracking data to at least one of mobile device 102, redemption tracking module 128 in back end server 110, or a third party redemption tracking server 114.

In one embodiment, POS system terminal 106 may not be equipped with a coupon redemption module 122 and may be unable to redeem the electronic coupons used in the purchase transaction. Thus, instead of POS system terminal 106 redeeming the electronic coupons locally, POS system terminal 106 may forward the electronic coupons along with purchase transaction information (e.g., “basket information” detailing the type and cost of items to be purchased by a consumer user) to back end server 110. Back end server 110 may then utilize a local electronic coupon redemption module 124 (executed by a processor in back end server 110) and the purchase transaction information to redeem the electronic coupons. For example, electronic coupon redemption module 124 may communicate with coupon redemption server 116, which may include a database of valid and/or invalid coupons. If the coupon used in the purchase transaction matches a valid entry and the purchase transaction data corresponds to the electronic coupon (i.e., a “soda X” being purchased with a “soda X” coupon), back end server 110 redeems the electronic coupons and generates adjusted purchase transaction information and redemption tracking data associated with the redeemed electronic coupon. For example, if an electronic coupon indicates that one dollar is to be subtracted from the price of a particular item priced at ten dollars, then back end server 110 will process the one dollar electronic certificate data along with the ten dollar price of the item (i.e., the purchase transaction information) to calculate a final price of nine dollars (i.e., the adjusted purchase transaction information). The adjusted purchase transaction information, which includes an updated price of an item to be purchased (i.e., a price that reflects the redeemed coupon as applied to the original sales price of the item to be purchased), is then sent to POS system terminal 106. In addition, the redemption tracking data (which indicates that the electronic coupon is to be applied to the purchase transaction) may also be provided to POS system terminal 106. In one embodiment, POS system terminal 106 then provides the redemption tracking data to at least one of mobile device 102, redemption tracking module 128 in back end server 110, or a third party redemption tracking server 114.

In yet another embodiment, a user may possess an NFC enabled device 102 that contains consumer identification data and one or more electronic certificate identifiers, e.g., electronic coupon identifiers, selected by the user. As used herein, an electronic coupon identifier is an identifier that may be used to identify one or more electronic coupons or electronic coupon books. In one embodiment, the electronic coupon identifier may be used to point to a database location (e.g., database 112) where the actual electronic coupons associated with the electronic coupon identifier are stored. The user may interface NFC enabled device 102 with reader 104 which wirelessly transfers the consumer identification information and the electronic coupon identifiers to reader 104. In one embodiment, reader 104 forwards the consumer identification data and the electronic coupon identifiers to POS system terminal 106 via a one or more communication ports connecting the two devices. Upon receiving the consumer identification information and electronic coupon identifiers, POS system terminal 106 may forward the electronic coupon identifiers to back end server 110 to be translated into electronic coupons. For example, back end server 110 may use the electronic coupon identifiers to access electronic coupon database 112 and obtain corresponding electronic coupons that can be applied to a purchase transaction. In one embodiment, back end server 110 sends the located electronic coupons to POS system terminal 106, where the coupons are to be redeemed and applied to the purchase transaction to be conducted. Upon receiving the electronic coupons, POS system terminal 106 may utilize electronic coupon redemption module 122 (executed by a processor in the POS system terminal 106) to redeem the electronic coupons while completing the purchase transaction. For example, electronic coupon redemption module 122 may communicate with a coupon redemption server 116. If the electronic coupon used in the purchase transaction is found to be valid, the purchase transaction is conducted by POS system terminal 106. After an electronic coupon is redeemed, POS system terminal 106 generates redemption tracking data associated with the redeemed electronic coupon. The redemption tracking data may include the type of electronic coupon redeemed (i.e., product purchased and amount of coupon), an identifier associated with the consumer that utilized the electronic coupon, and the time and location from which the electronic coupon was acquired by the consumer user. In one embodiment, POS system terminal 106 then provides the redemption tracking data to at least one of mobile device 102, redemption tracking module 128 in back end server 110, or a third party redemption tracking server 114.

Alternatively, instead of providing the electronic coupons back to POS terminal 106, back end server 110 may redeem the located electronic coupons locally. In such an embodiment, POS system terminal 106 previously provides back end server 110 with the appropriate purchase transaction information (i.e., “basket information”). Notably, back end server 110 may utilize a local electronic coupon redemption module 124 (executed by a processor in back end server 110) to redeem the electronic coupons. For example, electronic coupon redemption module 124 may communicate with coupon redemption server 116, which may include a database of valid and/or invalid coupons. If the electronic coupon to be redeemed matches a valid entry, back end server 110 redeems the electronic coupon and generates redemption tracking data associated with the redeemed electronic coupon as well as adjusted purchase transaction information. The adjusted purchase transaction information, which includes an updated price of an item to be purchased (i.e., a price that reflects the redeemed coupon as applied to the original sales price of the item to be purchased), is then sent to POS system terminal 106. In addition, the redemption tracking data may also be provided POS system terminal 106. In one embodiment, POS system terminal 106 then provides the redemption tracking data to at least one of mobile device 102, redemption tracking module 128 in back end server 110, or a third party redemption tracking server 114.

In one embodiment, a user may possess an NFC enabled device 102 that contains consumer identification data and one or more electronic certificate identifiers, e.g., electronic coupon identifiers, selected by the user. The user may interface NFC enabled device 102 with reader 104 which wirelessly transfers the consumer identification information and the electronic coupon identifiers to reader 104. In one embodiment, reader 104 forwards the consumer identification data and the electronic coupon identifiers directly to back end server 110. Upon receiving the consumer identification information and electronic coupon identifiers, back end server 110 initiates a process to translate the electronic certificates into electronic coupons. For example, back end server 110 may use the electronic certificates to access electronic coupon database 112 and obtain corresponding electronic coupons that can be applied to a purchase transaction. In one embodiment, back end server 110 sends the located electronic coupons to reader 104, where the coupons are forwarded with the consumer identification information to POS system terminal 106. Once the electronic coupons are received by POS system terminal 106, the purchase transaction process and coupon redemption process proceed as described above.

In another embodiment, a user may possess an NFC enabled device 102 that contains consumer identification data and one or more electronic coupons or electronic coupon identifiers selected by the user. The user may interface NFC enabled device 102 with reader 104 which wirelessly transfers the consumer identification information and the electronic coupons and/or electronic coupon identifiers to reader 104. In one embodiment, reader 104 forwards the consumer identification data and the electronic coupons or electronic coupon identifiers to back end server 110 via network 108. If electronic coupon identifiers are provided to back end server 110, then back end server 110 accesses database 112 to translate the electronic coupon identifiers into electronic coupons. Once back end server 110 is in possession of electronic coupons (either from directly from reader 104 or located in database 112), back end server 110 may be configured to initiate a redemption process. As mentioned above, back end server 110 may receive purchase transaction information (e.g., “basket information”) from POS system terminal 106. Back end server 110 may then utilize a local electronic coupon redemption module 124 (executed by a processor in back end server 110) and the purchase transaction information to redeem the electronic coupons. For example, electronic coupon redemption module 124 may communicate with coupon redemption server 116, which may include a database of valid and/or invalid coupons. If the coupon used in the purchase transaction matches a valid entry, back end server 110 redeems the electronic coupons and generates redemption tracking data associated with the redeemed electronic coupons as well as adjusted purchase transaction information. The adjusted purchase transaction information, which includes an updated price of an item to be purchased (i.e., a price that reflects the redeemed coupon as applied to the original sales price of the item to be purchased), is then sent to reader 104. Reader 104 then forwards the adjusted purchase transaction information to POS system terminal 106, which then finalizes the purchase transaction. In addition, the redemption tracking data may also be provided to reader 104. In one embodiment, reader 104 then provides the redemption tracking data to at least one of mobile device 102 or redemption tracking module 128 in back end server 110.

Once the redemption tracking data is generated by back end server 110 or POS terminal 106, the data is provided to one of a plurality of redemption tracking entities in system 100. In FIG. 1, each of the redemption tracking server 114, the service provider server 126, and the back end server 110 (using redemption tracking module 128) is a redemption tracking entity. For example, after back end server 110 generates the redemption tracking data, the data may be forwarded to reader 104. Reader 104 may then transmit the redemption tracking data to wallet client 120 in mobile device 102. Wallet client 120 may comprise a software application (e.g., a midlet or smart card web server applications) that when executed by a processor in mobile device 102 manages multiple softcards stored on a mobile device, such as credit cards, debit cards, electronic loyalty cards, electronic loyalty reward certificates, electronic coupons, electronic tickets, and the like. Wallet client 120 may also be configured to ensure end-to-end protection of transferring data to service provider server 126. Notably, service provider server 126 may wirelessly communicate with wallet client 120 and acquire the redemption tracking data to perform analysis and data processing. Alternatively, reader 104 may transmit the redemption tracking data to a third party redemption tracking server 114 or back to a redemption tracking module 128 in back end server 110, both of which may be used to perform analysis and data processing. In the embodiment where POS system terminal 106 generates the redemption tracking data, POS system terminal 106 may be configured to send the data to service provider server 126 via wallet client 120 or to redemption tracking server 114 or redemption tracking module 124 directly or via reader 104.

As indicated above, when an electronic coupon is redeemed at back end server 110, back end server 110 may be configured to send redemption tracking data to reader 104. In one embodiment, reader 104 is configured to forward the redemption tracking data to a wallet client 120 located in mobile device 102. The redemption tracking data may include consumer identification information that indicates which coupons selected from the consumer's mobile device were redeemed and which electronic coupons selected from the consumer's mobile device were not redeemed at back end server 110. By providing this redemption tracking data to NFC mobile device 102, wallet client 120 only has to delete the electronic coupons that were redeemed by back end server. Upon receiving redemption tracking data from back end server 110, wallet client 120 may also be configured to wirelessly forward the redemption tracking data to a service provider server 126. Service provider server 126 may include any network element associated with a service provider responsible for providing mobile services to mobile device 120.

The redemption tracking data may be of particular importance to service providers of mobile devices. Namely, service providers may enter agreements with a manufacturer/retailer to receive compensation not only the initial provisioning of an electronic coupon on a subscriber's mobile device, but also upon the ultimate redemption of the provisioned electronic coupon (since the electronic coupon actually helped facilitate a sale). Thus, a service provider participating in such an agreement with a manufacturer/retailer may be extremely interested in receiving redemption tracking data in a prompt manner.

Similarly, a service provider may also utilize redemption tracking data to determine whether a given geographical location has proven success at providing electronic coupons to mobile subscribers. For example, redemption tracking data may contain time stamp and location information associated with an electronic coupon or certificate obtained from a location. For example the redemption tracking information may include geographic location information, retail store information, or smart poster location information. If the redemption tracking data indicates that a high percentage of electronic coupons originating from that particular smart poster are being redeemed, then the service provider may utilize the data to conduct and accurately price a successful marketing campaign.

Each of the redemption tracking server 114, the service provider server 126, and the back end server 110 (using redemption tracking module 128), i.e., the redemption tracking entities, may be configured to conduct analysis on collected redemption tracking data. Exemplary analysis and processing performed by these redemption tracking entities include generating statistical reports used by both manufacturers and retailers, calculating credit amounts owed by a manufacturer to a retailer, determining specific certificate redemption rate information, and preventing fraudulent malredemption information. For example, redemption tracking module 128 can calculate amounts owed by a manufacturer to a retailer. Specifically, electronic coupon redemption data compiled by redemption tracking module 128 could timely calculate discount data associated with electronic coupons. Namely, retailers may desire this redemption data since discounts given by a retailer to redeem a manufacturer's coupons are in effect an extension of credit to the manufacturer.

Analysis performed by any one of the redemption tracking server 114, the service provider server 126, and the back end server 110 (using redemption tracking module 128) may also be configured to conduct analysis pertaining to marketing campaigns. For example, collected redemption tracking data may enable marketers to plan, execute and evaluate marketing efforts on a targeted basis. For example, generated statistics based on the collected redemption tracking data may be defined into regional, state, county, city, or zip code based statistics. As manufacturers or retailers learn what consumers purchase and what electronic coupons are redeemed, manufacturers and retailers can tailor future offers to individual consumer preferences based on geographical location. This evaluation may lead to new action plans for improving product and brand performance.

Lastly, the problem of malredemption and/or fraud can also be addressed by the present subject matter. Malredemption is a type of coupon fraud often practiced on a large scale. For example, malredemption can be characterized as a large scale collection of coupons which are subsequently submitted to the manufacturer for reimbursement despite the fact that the coupons were never used by consumers. Typically, malredemption is carried out by illegitimate retailers acting as a “front” for persons who have set up mass coupon clipping operations/systems. Malredemption fraud can cost manufacturers a significant amount of money on an annual basis. Instances of coupon fraud may be reduced or eliminated because it would be more difficult for retailers to submit coupons to the manufacturers that have actually never been redeemed or passed through hands of consumers. In addition, the problem of consumers using expired coupons, buying incorrect quantities, buying incorrect sizes, or automatic coupon doubling could also be prevented using this method.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for utilizing redemption tracking data, the method comprising:
receiving, at a wireless device reader, electronic certificate data and consumer identification data;
redeeming the electronic certificate data; and
generating redemption tracking data using the redeemed electronic certificate data and consumer identification data.

2. The method of claim 1 further comprising transmitting the redemption tracking data to a redemption tracking entity, wherein the redemption tracking entity includes at least one of a redemption tracking server, a redemption tracking module located within a back end server, and a service provider server.

3. The method of claim 2 wherein the redemption tracking entity is configured to use the redemption tracking data to perform analysis comprising at least one of generating statistical reports, calculating credit amounts owed by a manufacturer to a retailer, determining specific certificate redemption rate information, and preventing fraudulent malredemption information.

4. The method of claim 1 wherein the redeeming of the electronic certificate data is conducted by at least one of a back end server and a point of sale terminal.

5. The method of claim 4 wherein the back end server utilizes purchase transaction information received from the point of sale terminal to redeem the electronic certificate data.

6. The method of claim 1 wherein receiving electronic coupon data and consumer identification data includes receiving the electronic coupon data and the consumer identification data from a mobile device via near field communications (NFC).

7. The method of claim 1 wherein electronic certificate data comprises at least one of electronic coupon data, an electronic coupon identifier, loyalty data, reward data, and offer data.

8. A method for utilizing redemption tracking data, the method comprising:
receiving an electronic certificate identifier and consumer identification data;
utilizing the electronic certificate identifier to access a database in order to obtain electronic certificate data associated with the electronic certificate identifier;
redeeming the electronic certificate data; and
generating redemption tracking data using the redeemed electronic certificate data and consumer identification data.

9. The method of claim 8 wherein utilizing an electronic certificate identifier to access a database is performed by a back end server.

10. The method of claim 8 further comprising transmitting the redemption tracking data to a redemption tracking entity, wherein the redemption tracking entity includes at least one of a redemption tracking server, a redemption tracking module located within a back end server, and a service provider server.

11. The method of claim 10 wherein the redemption tracking entity is configured to use the redemption tracking data to perform analysis comprising at least one of generating statistical reports, calculating credit amounts owed by a manufacturer to a retailer, determining specific certificate redemption rate information, and preventing fraudulent malredemption information.

12. The method of claim 8 wherein the redeeming of the electronic certificate data is conducted by at least one of a back end server and a point of sale terminal.

13. The method of claim 12 wherein the back end server utilizes purchase transaction information received from the point of sale terminal to redeem the electronic certificate data.

14. A system for utilizing redemption tracking data, the system comprising:
a wireless device reader for receiving electronic certificate data and consumer identification data; and
a point of sale (POS) system terminal for receiving the electronic certificate data and the consumer identification data from the wireless device reader, for redeeming the electronic certificate data, and generating electronic redemption tracking data from the electronic certificate data and consumer identification.

15. The system of claim 14 wherein the POS system terminal transmits the redemption tracking data to the wireless device reader and wherein the wireless device reader transmits the redemption tracking data to the mobile device via NFC.

16. The system of claim 14 wherein a wallet client in the mobile device transfers the redemption tracking data to a service provider server and wherein the service provider server uses the redemption tracking data to perform at least one of generating statistical reports, calculating credit amounts owed by a manufacturer to a retailer, determining specific certificate redemption rate information, and preventing fraudulent malredemption information.

17. The system of claim 14 wherein the wireless device reader is configured to receive electronic certificate data and consumer identification data from a mobile device via near field communications (NFC).

18. A system for utilizing redemption tracking data, the system comprising:
a wireless device reader for receiving and electronic certificate identifier and consumer identification data; and
a back end server for receiving the electronic certificate identifier and the consumer identification data from the wireless device reader, for utilizing the electronic certificate identifier to access a database in order to obtain electronic certificate data associated with the electronic certificate identifier, for redeeming the electronic certificate data, and for generating redemption tracking data using the redeemed electronic certificate data and consumer identification data.

19. The system of claim 15 wherein the back end server receives, from a point of sale terminal, purchase transaction information used to redeem the electronic certificate data.

20. The system of claim 15 wherein the back end server is configured provide the redemption tracking data to a redemption tracking entity, wherein the redemption tracking entity includes at least one of a redemption tracking server, a redemption tracking module located within the back end server, and a service provider server.

21. The system of claim 20 wherein the redemption tracking entity is configured to use the redemption tracking data to perform analysis comprising at least one of generating statistical reports, calculating credit amounts owed by a manufacturer to a retailer, determining specific certificate redemption rate information, and preventing fraudulent malredemption information.

22. A non-transitory computer readable medium having stored thereon executable instructions that when executed by the processor of a computer control the computer to perform steps comprising:
receiving, at a wireless device reader, electronic certificate data and consumer identification data;
redeeming the electronic certificate data; and
generating redemption tracking data using the redeemed electronic certificate data and consumer identification data.
